(19) United States
(12) Patent Application Publication
(10) Pub. No.: US 2024/0093697 A1
(43) Pub. Date: Mar. 21, 2024

(54) Centrifugal Fan With Retrofittable Air Guide Segments

(71) Applicant: ebm-papst Mulfingen GmbH & Co. KG, Mulfingen (DE)

(72) Inventors: Christian SZEIFERT, Bad Mergentheim (DE); Moritz HELLER, Tauberrettersheim (DE)

(21) Appl. No.: 18/469,621

(22) Filed: Sep. 19, 2023

(30) Foreign Application Priority Data
Sep. 21, 2022 (DE) 10 2022 124 201.3

(51) Int. Cl. F04D 29/44; F04D 17/08; F04D 29/28

(52) U.S. Cl. CPC F04D 29/441; F04D 17/08; F04D 29/281

(57) ABSTRACT

A centrifugal fan (1) has a fan unit (10) with an impeller (11), a motor (12) for driving the impeller (11), and a support structure (13) for securing the fan unit (10) in the intended detachable manner to a flange plate with an intake opening (21, 22). The support structure (13) is designed to hold the fan unit (10) on the flange plate (21, 22) by itself. A plurality of air guide segments (23), that together form a downstream guide device (20), are secured to the support structure (13) and/or to the flange plate (21, 22).

### CROSS-REFERENCE TO RELATED APPLICATION

This application claims the benefit and priority of German Application No. 10 2022 121 693.4, filed Aug. 26, 2022. The entire disclosure of the above application is incorporated herein by reference.

### FIELD

The disclosure relates to a centrifugal fan or a centrifugal fan with retrofittable air guide segments and a system for providing a retrofittable centrifugal fan.

### BACKGROUND

A large number of centrifugal fans are known from the prior art which are mostly optimized for a specific application. If such a centrifugal fan is installed at its place of use and another, more efficient centrifugal fan is required there later, for example, the centrifugal fan that is already installed usually has to be completely replaced.

Furthermore, modularized centrifugal fans are already known in which modules such as a downstream guide device consisting of air guide segments can be retrofitted in order to increase efficiency. With those, however, additional components and, in particular, an entire structure for ensuring stability often have to be switched out, so that essentially only the motor and the impeller are transferred from an old housing to a new housing.

It is therefore the object of the disclosure to overcome the aforementioned drawbacks and provide a centrifugal fan and a system for the provision of a centrifugal fan in which air guide segments can be retrofitted in a simple and cost-efficient manner.

### SUMMARY

This object is achieved by the combination of features according to claim 1.

According to the disclosure, a centrifugal fan is proposed which has a fan unit. The fan unit comprises an impeller, a motor for driving the impeller, and a support structure for securing the fan unit in the intended detachable manner to a flange plate having an intake opening. In particular, the fan unit can also consist of the impeller, the motor, and the support structure. According to the disclosure, a provision is made that the support structure is designed to hold the fan unit on the flange plate by itself. Furthermore, a plurality of air guide segments which together form a downstream guide device can be secured to the support structure and/or to the flange plate.

The fact that the support structure is designed to hold the fan unit on the flange plate by itself means that the support structure alone is sufficient to hold and fix the fan unit on the flange plate particularly in a detachable manner, so that no further components are required for that purpose. It goes without saying that, for example, downstream guide devices that are secured both to the flange plate and to the support structure can support the holding of the support structure on the flange plate but are not necessary for this.

Accordingly, the fan unit is designed to be held on the flange plate solely by means of the support structure, which is also preferably designed to hold air guiding segments forming a downstream guide device.

In summary, it is therefore proposed that a centrifugal fan be provided whose efficiency can be improved by subsequently attaching air guide segments to the support structure of the centrifugal fan and/or flange plate without having to replace all of the other components that make up the outer structure of the centrifugal fan.

If the air guide segments are suitably designed, it may be possible to dispense with replacing the flange plate. This is the case, for example, when the air guide segments do not go beyond the (first) flange plate in the radial direction. Alternatively, a provision can also be made that the air guide segments protrude only in some portions beyond the (first) flange plate and end with the flange plate on their side adjoining the flange plate.

The effectiveness or the efficiency of the centrifugal fan can be increased by the air guide segments or the downstream guide device formed by them, it being possible for the air guide segments to be aerodynamically optimized for this purpose particularly through their shape or their surface.

A provision is preferably made that the flange plate has to be replaced, but not the support structure, since the motor and the impeller are held on the flange plate exclusively by means of the support structure, so that, independently of the air guide segments or a downstream guide device, no further components are required. As explained previously, the air guide segments or the downstream guide device can support the support structure but are not necessary for the intended holding of the motor and impeller on the flange plate.

It is therefore especially preferred if the air guide segments and, in particular, also the downstream guide device formed by them do not assume any function that supports the fan unit on the flange plate or on the support structure. That function is preferably fulfilled exclusively by the support structure.

One advantageous refinement makes a provision that the support structure is formed from at least two and, in particular, four support arms which extend from a motor mount for securing to the motor in the axial direction past the impeller, engaging around the same, to the flange plate. This enables one air guide segment to be secured to one support arm, so that the downstream guide device is formed from two and, in particular, four individual air guide segments. The axial direction preferably corresponds to the axis of rotation about which the impeller can be driven by the motor.

Also advantageous is a variant in which the fan unit can be secured with the support structure to a first flange plate on which no mounting elements for securing air guide segments are provided and can also be secured with the support structure to a second flange plate that does have mounting elements for securing air guide segments. Accordingly, the flange plates are interchangeable, and the support structure is compatible with both the first and the second flange plate. Accordingly, the support structure preferably corresponds to both the first flange plate and the second flange plate.

The first flange plate preferably provides at least two connecting portions for securement to the support structure. These span a base area and/or are arranged in the corners of such a base area, it being possible in particular for the basic shape to correspond to the basic shape of the first flange plate and to be rectangular or square, for example.

Furthermore, an embodiment is also advantageous in which the second flange plate provides at least two connecting portions for securement to the support structure which span a mounting surface and/or are arranged in corners of the mounting surface. The mounting surface lies in the second flange plate and is rotated by a predetermined angle with respect to an outer contour of the second flange plate.

Building upon this, one refinement makes a provision that the base of the first flange plate corresponds to the mounting surface of the second flange plate and/or is rotated by an angle of between 10° and 20°, more particularly 15°, relative to the outer contour of the second flange plate. It is advantageous in this regard that the regions of the second flange plate lying outside the mounting surface be able to provide a wall for the flow channels, which are delimited in the circumferential direction by the second flange plate and the air guide segments. Accordingly, the air guide segments can extend beyond the base area defined by the first flange plate and, more preferably, end with a basic shape of the second flange plate.

In order to minimize the number of different components, the air guide segments can be identical to one another.

Alternatively, however, several types of air guide segments can also be provided, with the respective air guide segments of one type being identical and the downstream guide device being formed, for example, from two air guide segments of a first type and two air guide segments of a second type.

Furthermore, one air guide segment is preferably provided for each support arm of the support structure. The respective air guide segment also provides, in particular, a hinge portion for gripping around a respective support arm, enabling the respective air guide segment to be hooked onto a support arm.

Especially advantageously, a respective air guide segment defines a flow channel that runs in the circumferential direction and leads radially outward from the impeller, which flow channel opens in the circumferential direction into an exhaust opening. The flow channel, more particularly the cross-sectional area thereof, can also widen spirally from radially inside to radially outside.

The air guide segments can also each have first connecting portions for attachment to the air guide segments that are directly adjacent in the circumferential direction and/or second connecting portions for attachment to the second flange plate and, in particular, to an edge of the second flange plate, and/or they can be hooked into the support structure by means of a hinge portion, so that the individual air guide segments can be securely connected to one another to form the downstream guide device.

If the support structure has a motor mount for securement to the motor, the air guide segments can also be fastened or fastenable to the motor mount.

In addition, sealing elements can be provided between the individual air guide segments and adjacent components, such as the flange plate and/or the motor mount.

A further aspect of the disclosure relates to a system for providing a centrifugal fan that can be retrofitted with air guide segments. The system includes a fan assembly, a first flange plate, a second flange plate, and a plurality of airfoil segments. The fan unit comprises an impeller, a motor for driving the impeller, and a support structure for securing the fan unit in the intended detachable manner to the first or second flange plate, which has an intake opening. The support structure is thus preferably compatible with both the first and the second flange plate. The support structure is also designed to hold the fan unit alone, i.e., without additional components for supporting the fan unit on the respective flange plate and preferably on connecting portions provided by the flange plate. However, screws or equivalent connecting means can be provided in order to connect the support structure to the respective flange plate and particularly to the connecting portions of the flange plate. The compatibility enables the fan unit to be secured with the support structure both to the first flange plate, which is particularly free of mounting elements or connecting portions for securing air guide segments, and to the second flange plate, which has mounting elements or connecting portions for securing the air guide segments.

The features described above relating to the centrifugal fan can also be applied directly to the system.

The features disclosed above can be combined as required, provided this is technically possible and they do not contradict one another.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

Other advantageous developments of the disclosure are illustrated in the dependent claims or are described in more detail below together with the description of the preferred embodiment of the disclosure with reference to the figures.

FIG. 1 shows a centrifugal fan with the first flange plate;

FIG. 2 shows an air guide segment; and

FIG. 3 shows the centrifugal fan with the second flange plate and the air guide segments.

### DETAILED DESCRIPTION

The figures are diagrammatic examples. Identical reference numerals in the figures indicate identical functional and/or structural features.

The figures are schematic examples. Same reference symbols in the figures indicate same functional and/or structural features.

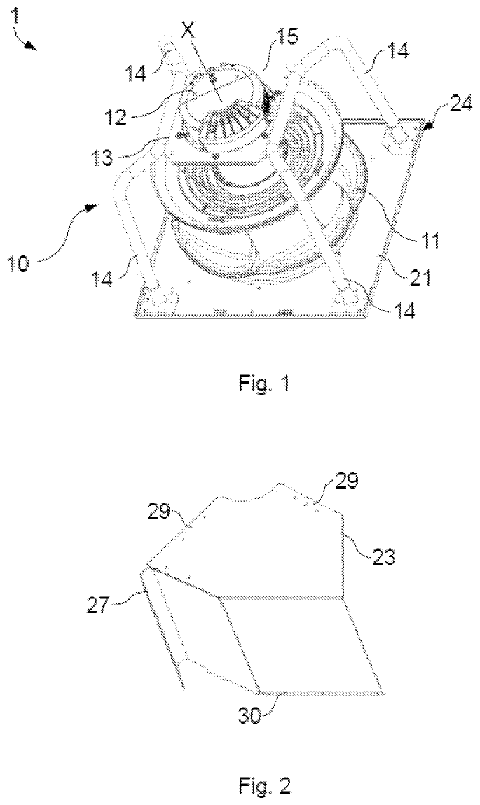

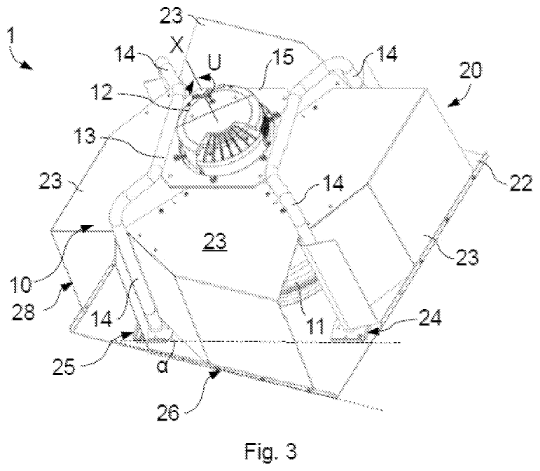

FIG. 1 shows a centrifugal fan 1 in the first configuration, in which the fan unit 10 consisting of impeller 11, motor 12, and support structure 13 is secured with the support structure 13 to a first flange plate 21, to which no air guide segments can be attached. In this case, the fan unit 10 is preferably held on the flange plate 21 exclusively, i.e., solely, by the support structure 13. The intake opening provided by the flange plate 21 is covered by the impeller 11 in both FIG. 1 and FIG. 3.

In order to now increase the efficiency of the centrifugal fan 1, the first flange plate 21 can be exchanged for the second flange plate 22, as is the case in FIG. 3. During or after the replacement of the flange plates 21, 22, four air guide segments 23 are arranged on the support structure 13, with a respective air guide segment 23 having a respective hinge portion 27 being hung on a respective supporting arm 14 of the support structure 13. The air guide segments 23 are then connected via their first connecting portions 29 to the respective air guide segment 23 that is adjacent in the circumferential direction U and via their second connecting portions 30 to the second flange plate 22.

The air guide segments 23 together form a downstream guide device 20 for optimizing the flow generated by the impeller 11, with each defining a flow channel that leads from radially inside to radially outside.

Although not the case here, it is possible for the individual air guide segments 23 to also have a connecting portion for securement to the motor mount 15 at which the motor 12 is connected to the support structure 13 or secured in the support structure 13.

As can be seen in FIGS. 1 and 3, the first flange plate 21 and the second flange plate 22 each have a rectangular or square basic shape. The first flange plate 22 has a connecting portion 24 in each corner for securing the support structure 14, the connecting portions 24 together spanning a base area which, in the present case, corresponds to the basic shape of the first flange plate 21.

In order to ensure the compatibility of the support structure with the first and second flange plates 21, 22, a mounting surface 25 is provided in or as part of the second flange plate 22 corresponding to the base area defined by the connecting portions 24, which in this case corresponds to the basic shape of the first flange plate and is tilted by a predetermined angle α, and specifically 15° here, relative to the basic shape of the second flange plate 22 or relative to the outer contour 26 of the second flange plate 22. The regions lying outside of the mounting surface 25 define a wall, each forming a flow channel together with the air guide segments 23.

The disclosure is not limited in its execution to the abovementioned preferred exemplary embodiments. Rather, a number of variants are conceivable which make use of the illustrated solution even in the form of fundamentally different embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-11. (canceled)

12. A centrifugal fan comprising:
a fan unit comprising an impeller, a motor for driving the impeller, and a support structure for securing the fan unit in an intended detachable manner to a flange plate with an intake opening;
the support structure is designed to hold the fan unit on the flange plate by itself; and
a plurality of air guide segments form a downstream guide device secured to the support structure and/or to the flange plate.

13. The centrifugal fan as set forth in claim 12,
wherein the support structure is formed from at least two and, in particular, four support arms that extend from a motor mount for securing to the motor in the axial direction past the impeller, engaging around the same, to the flange plate,
and wherein a respective air guide segment can be secured to a respective support arm.

14. The centrifugal fan as set forth in claim 12,
wherein the fan unit can be secured with the support structure to a first flange plate devoid of mounting elements for securing air guide segments,
and the fan unit with the support structure can be secured to a second flange plate that includes mounting elements for securing air guide segments.

15. The centrifugal fan as set forth in claim 12,
wherein the first flange plate provides at least two connecting portions for securement to the support structure that span a base area and/or are arranged in corners of the base area,
and the base area corresponds to a basic shape of the first flange plate.

16. The centrifugal fan as set forth in claim 14,
wherein the second flange plate includes at least two connecting portions for securing to the support structure that span a mounting surface and/or are arranged in corners of the mounting surface,
and the mounting surface lies in the second flange plate rotated by a predetermined angle (α) relative to an outer contour of the second flange plate.

17. The centrifugal fan as set forth in claim 16,
wherein the base area of the first flange plate corresponds to the mounting surface of the second flange plate and/or is rotated by the angle (α) of between 10° and 20° relative to the outer contour of the second flange plate.

18. The centrifugal fan as set forth in claim 12, wherein the air guide segments are identical to one another.

19. The centrifugal fan as set forth in claim 13,
wherein an air guide segment is included for each support arm of the support structure,
the respective air guide segment including a hinge portion for engaging around a respective support arm, enabling the respective air guide segment to be hooked onto a support arm.

20. The centrifugal fan as set forth in claim 12,
wherein a respective air guide segment defines a flow channel that runs in the circumferential direction (U) and leads radially outward from the impeller, the flow channel opens in the circumferential direction (U) into an exhaust opening.

21. The centrifugal fan as set forth in claim 12,
wherein the air guide segments each have first connecting portions for attachment to the air guide segments that are immediately adjacent in the circumferential direction (U) and/or second connecting portions for attachment to the second flange plate and to an edge of the second flange plate, and/or they can be hooked into the support structure by a hinge portion.

22. A system for providing a centrifugal fan that can be retrofitted with air guide segments comprising:
the system having a fan unit, a first flange plate, a second flange plate, and a plurality of air guide segments,
the fan unit has an impeller, a motor for driving the impeller, and a support structure for the purpose of detachably securing the fan unit to the first or second flange plate having an intake opening;
the support structure is designed to hold the fan unit on the flange plate by itself;
the fan unit can be secured with the support structure to the first flange plate, which in particular is free of mounting elements for securing air guide segments;
and the fan unit can be secured with the support structure to the second flange plate, which has mounting elements for securing the air guide segments.
